(19) United States
(12) Patent Application Publication
(10) Pub. No.: US 2017/0262454 A1
(43) Pub. Date: Sep. 14, 2017

(54) SYSTEM AND METHOD FOR RECOMMENDING TRENDING CONTENT BASED ON CONTEXT

(71) Applicant: Cortica, Ltd., TEL AVIV (IL)

(72) Inventors: Igal Raichelgauz, Tel Aviv (IL); Karina Odinaev, Tel Aviv (IL); Yehoshua Y Zeevi, Haifa (IL)

(73) Assignee: Cortica, Ltd., TEL AVIV (IL)

(21) Appl. No.: 15/605,521

(22) Filed: May 25, 2017

Related U.S. Application Data
(63) Continuation-in-part of application No. 15/601,309, filed on May 22, 2017.
Application No. 15/601,309 is a continuation-in-part of application No. 15/463,414, filed on Mar. 20, 2017.
Application No. 15/463,414 is a continuation-in-part of application No. 13/770,603, filed on Feb. 19, 2013.
Application No. 13/770,603 is a continuation-in-part of application No. 13/624,397, filed on Sep. 21, 2012, now Pat. No. 9,191,626.
Application No. 13/624,397 is a continuation-in-part of application No. 13/344,400, filed on Jan. 5, 2012, now Pat. No. 8,959,037.
Application No. 13/344,400 is a continuation of application No. 12/434,221, filed on May 1, 2009, now Pat. No. 8,112,376.
Application No. 13/624,397 is a continuation-in-part of application No. 12/195,863, filed on Aug. 21, 2008, now Pat. No. 8,326,775.
Application No. 12/195,863 is a continuation-in-part of application No. 12/084,150, filed on Apr. 7, 2009, now Pat. No. 8,655,801.
Application No. 13/624,397 is a continuation-in-part of application No. 12/084,150, filed on Apr. 7, 2009, now Pat. No. 8,655,801.
(60) Provisional application No. 62/341,127, filed on May 25, 2016.
(60) Provisional application No. 62/339,913, filed on May 22, 2016.
(60) Provisional application No. 62/310,743, filed on Mar. 20, 2016.

(30) Foreign Application Priority Data
Oct. 26, 2005 (IL) 171577
Jan. 29, 2006 (IL) 173409
Aug. 21, 2007 (IL) 185414

(51) Int. Cl. G06F 17/30; H04H 60/46; H04H 60/66; H04N 7/173; H04N 21/258; H04N 21/2668; H04N 21/466; H04N 21/81; H04H 20/26; H04H 60/37; H04H 60/56; H04H 20/10; H04L 29/08

(52) U.S. Cl. CPC G06F 17/30056; H04H 20/103; H04H 60/46; H04H 60/66; H04N 7/17318; H04N 21/25891; H04N 21/2668; H04L 67/10; H04N 21/8106; H04H 20/26; H04H 60/37; H04H 60/56; H04N 21/466

(57) ABSTRACT

A system and method for method for recommending trending content. The method includes causing generation of at least one signature for each of at least one input multimedia content element, wherein each signature represents a concept, wherein each concept is a collection of signatures and metadata describing the concept; comparing the generated signatures to signatures of a plurality of reference multimedia content elements, wherein each reference multimedia content element is associated with a context indicating a trend; determining, based on the comparison, at least one trending multimedia content element of the at least one input multimedia content element; and generating a recommendation notification, wherein the recommendation notification includes at least one of: the at least one trending multimedia content element, and an indication of the at least one trending multimedia content element.

### CROSS-REFERENCE TO RELATED APPLICATIONS

This application claims the benefit of U.S. Provisional Application No. 62/341,127, filed on May 25, 2016. This application is also a continuation-in-part of U.S. patent application Ser. No. 15/601,309, filed on May 22, 2017, now pending, which claims the benefit of U.S. Provisional Application No. 62/339,913 filed on May 22, 2016. The Ser. No. 15/601,309 application is also a continuation-in-part (CIP) of U.S. patent application Ser. No. 15/463,414, filed on Mar. 20, 2017, now pending, which claims the benefit of U.S. Provisional Application No. 62/310,743 filed on Mar. 20, 2016. The Ser. No. 15/463,414 Application is a CIP of U.S. patent application Ser. No. 13/770,603 filed on Feb. 19, 2013, now pending, which is a CIP of U.S. patent Application Ser. No. 13/624,397 filed on Sep. 21, 2012, now U.S. Pat. No. 9,191,626. The Ser. No. 13/624,397 Application is a CIP of:

(a) U.S. patent application Ser. No. 13/344,400 filed on Jan. 5, 2012, now U.S. Pat. No. 8,959,037, which is a continuation of U.S. patent application Ser. No. 12/434,221 filed on May 1, 2009, now U.S. Pat. No. 8,112,376;

(b) U.S. patent application Ser. No. 12/195,863 filed on Aug. 21, 2008, now U.S. Pat. No. 8,326,775, which claims priority under 35 U.S.C 119 from Israeli Application No. 185414, filed on Aug. 21, 2007, and which is also a CIP of the below-referenced U.S. patent application Ser. No. 12/084,150; and,

(c) U.S. patent application Ser. No. 12/084,150 having a filing date of Apr. 7, 2009, now U.S. Pat. No. 8,655,801, which is the National Stage of International Application No. PCT/IL2006/001235, filed on Oct. 26, 2006, which claims foreign priority from Israeli Application No. 171577 filed on Oct. 26, 2005, and Israeli Application No. 173409 filed on Jan. 29, 2006.

All of the applications referenced above are herein incorporated by reference.

### TECHNICAL FIELD

The present disclosure relates generally to the analysis of multimedia content, and more specifically to identifying trends and suggesting the uploading of multimedia content from a user device that fall within a trend.

### BACKGROUND

Content uploaded to web platforms plays an increasingly significant role in people's lives. The web platforms may include, for example, social networks, video sharing websites, chatrooms, news feeds, and so on. Such web platforms allow users to communicate and share content with other users. Some web platforms monitor trending content that is viewed by a relatively large number of users to provide the trending content to other users in, e.g., a “Trending Topics” or similar list. For example, “viral videos” may be videos uploaded to YouTube® or other web platforms which are viewed a large number of times. Moreover, trendiness of content may be based on feedback (e.g., “likes,” shares, etc.) from other users.

As a large amount of content is uploaded by social media users every day, it can be difficult for a user to effectively reach their desired audience with an upload of a photo, video or comment. Other users are only able to consume a certain amount of content on a daily basis, and tend to be drawn toward trending topics. However, it can be difficult for a user posting content to ascertain which photo, video or comment of theirs would likely be popular among their desired audience. Currently, there is no method of detecting which content created by a user would most likely invoke a positive and a popular reaction.

It would therefore be advantageous to provide a solution that overcomes the deficiencies noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for recommending trending content. The method comprises: causing generation of at least one signature for each of at least one input multimedia content element, wherein each signature represents a concept, wherein each concept is a collection of signatures and metadata describing the concept; comparing the generated signatures to signatures of a plurality of reference multimedia content elements, wherein each reference multimedia content element is associated with a context indicating a trend; determining, based on the comparison, at least one trending multimedia content element of the at least one input multimedia content element; and generating a recommendation notification, wherein the recommendation notification includes at least one of: the at least one trending multimedia content element, and an indication of the at least one trending multimedia content element.

Certain embodiments disclosed herein also include a non-transitory computer readable medium having stored thereon instructions for causing a processing circuitry to perform a process, the process comprising causing generation of at least one signature for each of at least one input multimedia content element, wherein each signature represents a concept, wherein each concept is a collection of signatures and metadata describing the concept; comparing the generated signatures to signatures of a plurality of reference multimedia content elements, wherein each reference multimedia content element is associated with a context indicating a trend; determining, based on the comparison, at least one trending multimedia content element of the at least one input multimedia content element; and generating a recommendation notification, wherein the recommendation notification includes at least one of: the at least one trending multimedia content element, and an indication of the at least one trending multimedia content element.

Certain embodiments disclosed herein also include a system for recommending trending content. The system comprises: a processing circuitry; and a memory, the memory containing instructions that, when executed by the processing circuitry, configure the system to: cause generation of at least one signature for each of at least one input multimedia content element, wherein each signature represents a concept, wherein each concept is a collection of signatures and metadata describing the concept; compare the generated signatures to signatures of a plurality of reference multimedia content elements, wherein each reference multimedia content element is associated with a context indicating a trend; determine, based on the comparison, at least one trending multimedia content element of the at least one input multimedia content element; and generate a recommendation notification, wherein the recommendation notification includes at least one of: the at least one trending multimedia content element, and an indication of the at least one trending multimedia content element.

### BRIEF DESCRIPTION OF THE DRAWINGS

The disclosed subject matter is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a flowchart illustrating a method for recommending trending content.

FIG. 3 is a block diagram depicting the basic flow of information in the signature generator system.

FIG. 4 is a diagram illustrating the flow of patches generation, response vector generation, and signature generation in a large-scale speech-to-text system.

FIG. 5 is a block diagram of a trending content identifier according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

Various embodiments disclosed herein allow for identifying trending content and recommending such content for, e.g., uploading or posting. The trending content may be, for example, multimedia content elements (MMCEs) located on a user device that are trending or are otherwise related to a trending topic. In an embodiment, one or more input MMCEs is identified and recommended as trending content. Recommending the content may include, but is not limited to, sending the trending MMCEs, sending a notification indicating the trending MMCEs, and the like.

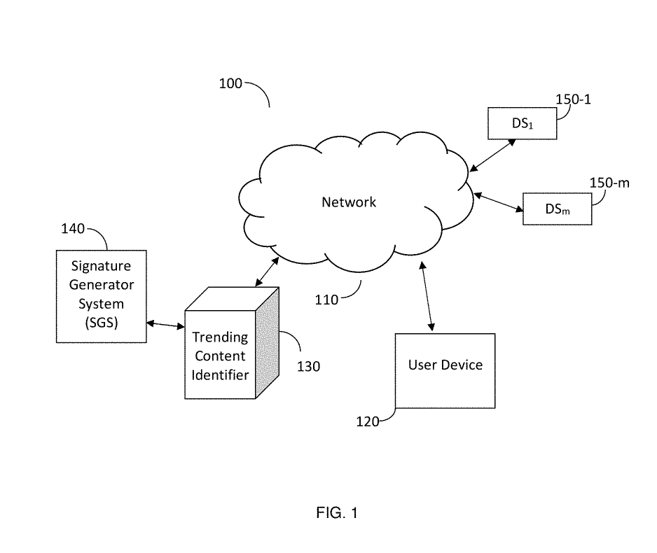

FIG. 1 shows a network diagram 100 utilized to describe the various disclosed embodiments. The example network diagram 100 includes a user device (UD) 120, a trending content identifier 130, a signature generator system (SGS) 140, and a plurality of data sources 150-1 through 150-m (hereinafter referred to collectively as data sources 150 or individually as a data source 150, merely for simplicity purposes), communicatively connected via a network 110. The network 110 may be, but is not limited to, the Internet, the world-wide-web (WWW), a local area network (LAN), a wide area network (WAN), a metro area network (MAN), and other networks capable of enabling communication between the elements of the network diagram 100.

The user device 120 may be, but is not limited to, a personal computer (PC), a personal digital assistant (PDA), a mobile phone, a smart phone, a tablet computer, a wearable computing device and other kinds of wired and mobile appliances, equipped with storing, capturing, viewing, listening, filtering, managing, and other capabilities that are enabled as further discussed herein below.

The data sources 150 include potential reference MMCEs, and may further include metadata. Each potential reference MMCE may be trending, e.g., as indicated by a number of appearances of the MMCE in one or more of the data sources 150, a number of likes, a number of shares, a number of comments, and other indicators of interest. Potential reference MMCEs that are trending may be utilized to identify input MMCEs related to trending content. To this end, the data sources 150 may be related to social media websites or other entities allowing for sharing content, responding to content, or both.

The metadata may be related to sentiments expressed by viewers of the reference MMCEs and may include, but is not limited to, responses, view data (e.g., number of viewers, number of views, number of clicks, number of downloads, etc.), time indicators, combinations thereof, and the like. The responses may be in the form of, for example, explicit identifiers of approval and disapproval or interest and disinterest (e.g., “likes”, “dislikes”, “upvotes”, “downvotes”, etc.), comments, numbers of comments, rating values (e.g., numerical values on a scale of 1 to 10), combinations thereof, and the like. The comments may include, but are not limited to, text, multimedia content (e.g., emoji), combinations thereof, and the like. Each of the data sources 150 may be, for example, a web page, a website, an application, a social network platform, a blog, a chat, a news feed, a data repository, a database, and the like. In an example implementation, the data sources 150 include web sources available over the Internet.

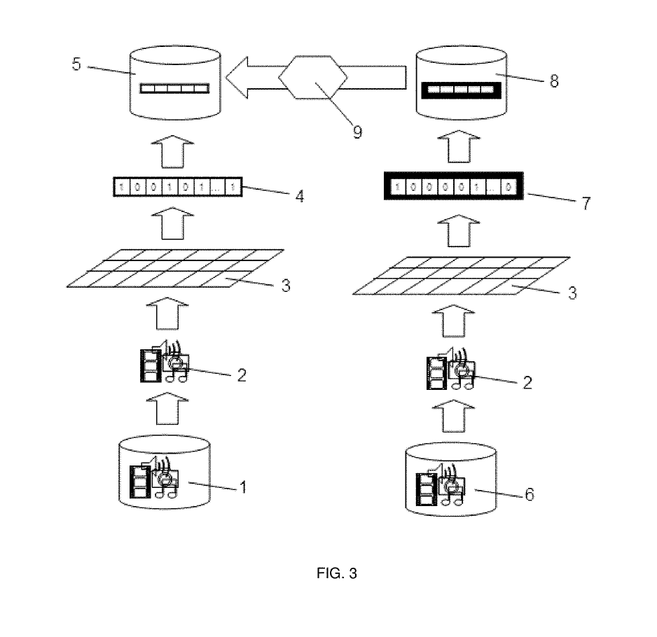

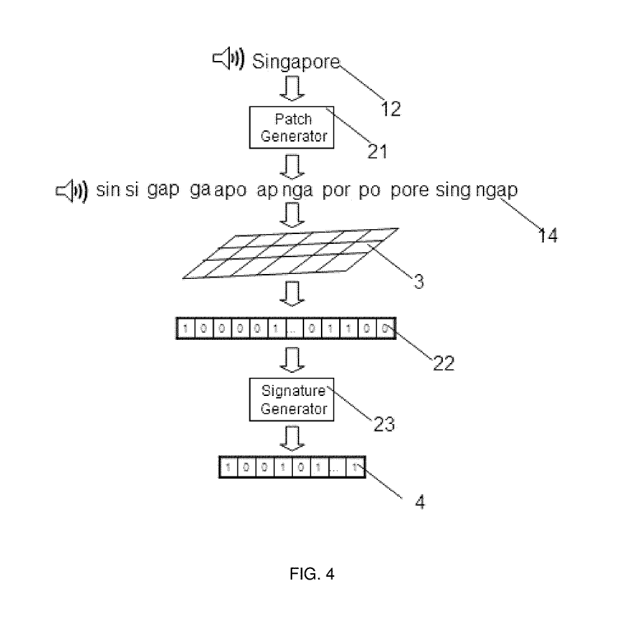

Various embodiments disclosed herein are realized using the trending content identifier 130 and a signature generator system (SGS) 140. The SGS 140 may be connected to the trending content identifier 130 directly or through the network 110. The trending content identifier 130 is configured to receive and analyze MMCEs and to generate or cause the SGS 140 to generate signatures for the MMCEs. The process for generating the signatures for the MMCEs is explained in greater detail herein below with respect to FIGS. 3 and 4.

In an embodiment, the trending content identifier 130 is configured to access one or more input MMCEs. The input MMCEs may be MMCEs to potentially be shared and may be, e.g., stored on the user device 120, stored in one or more of the data sources 150, and the like. In a further embodiment, the input MMCEs are stored remotely and accessed through a remote server. For example, the input MMCEs may be part of a user social media account. The input MMCEs may be, e.g., received, or may be retrieved at, for example, predetermined time intervals or upon a user request. In a further embodiment, the trending content identifier 130 is further configured to analyze the input MMCEs, metadata associated with the input MMCEs, or both, to determine at least one context. The at least one context may be determined based on a plurality of signatures generated for each input MMCE.

To this end, in yet a further embodiment, the trending content identifier 130 is configured to cause generation of at least one signature for each input MMCE. The generated signatures may be robust to noise and distortion as discussed herein below. In an embodiment, causing generation of the signatures for each input MMCE may include, but is not limited to, sending each input MMCE to the SGS 140 and receiving the signatures generated by the SGS 140. In another embodiment, the trending content identifier 130 may be configured to generate the at least one signature for each input MMCE as described herein.

Each signature generated for a MMCE represents a concept. A concept is a collection of signatures representing MMCEs and metadata describing the concept, and acts as an abstract description of the content to which the signature was generated. As an example, metadata of a concept represented by the signature generated for a picture showing a bouquet of red roses is “flowers.” As another example, metadata of a concept represented by the signature generated for a picture showing a bouquet of wilted roses is “wilted flowers.” According to these examples, a correlation between concepts can be achieved by probabilistic models to determine that the concept of “flowers” has a positive connotation in comparison to the concept “wilted flowers.” Moreover, the correlation between concepts can be achieved by identifying a ratio between signatures' sizes, a spatial location of each signature, and so on using the probabilistic models.

In an embodiment, the trending content identifier 130 additionally accesses signatures for a plurality of reference MMCEs stored in the data sources 150. In an embodiment, the trending content identifier 130 generates the signatures for the plurality of reference MMCEs. In a further embodiment, the trending content identifier 130 accesses a list of previously generated signatures associated with each of the plurality of reference MMCEs.

In an embodiment, the trending content identifier 130 is configured to identify at least one trending MMCE from among the input MMCEs. In a further embodiment, the identification includes comparing signatures generated for the input MMCEs to signatures of a plurality of reference MMCEs to identify at least one matching reference MMCE. In yet a further embodiment, the trending content identifier 130 is configured to determine, based on the comparison, whether signatures of each input MMCE match signatures of at least one of the reference MMCEs above a predetermined threshold. Each input MMCE having signatures matching signatures of at least one of the reference MMCEs above a predetermined threshold may be determined to be trending content and, therefore, recommended for sharing.

Each reference MMCE is associated with a context indicating a trend, i.e., the context of each reference MMCE indicates that the reference MMCE is trending (e.g., on social media). In an embodiment, each reference MMCE may be associated with a predetermined context indicating the trend. In an example implementation, a context may indicate a trend if, e.g., a sentiment of the context is popular or both popular and positive.

In another embodiment, the trending content identifier 130 may be configured to select the reference MMCEs from among a plurality of potential reference MMCEs stored in the data sources 150. In a further embodiment, selecting the reference MMCEs may include determining a context of each reference MMCE, where the selected reference MMCEs are associated with contexts meeting a sentiment threshold with respect to, for example, a required sentiment, a minimum sentiment value, or both.

It should be noted that at least one signature may be generated for each portion of the metadata (e.g., each comment, each value included in the view data, each number of explicit approval or disapproval identifiers, each time indicator, and combinations thereof). Accordingly, signatures of a plurality of values for view data, comments, and the like, may represent a plurality of concepts. Accordingly, correlations among such concepts for a potential reference MMCE may be utilized to determine the degree to which a particular sentiment is related to the potential reference MMCE. For example, if the signatures show a high number of comments, the sentiment of the potential reference MMCE may be or may include “popular.” More specifically, if the signatures show a high number of comments including positive language (e.g., “like,” “love,” “enjoy,” etc.), the sentiment of the potential reference MMCE may further include “positive.”

In an embodiment, the trending content identifier 130 is configured to analyze the signatures for the potential reference MMCEs to correlate between their respective concepts and to determine at least one context of such a correlation. Each context represents a sentiment with respect to the potential reference MMCE. In a further embodiment, the determined sentiment may be a positive, neutral, or negative sentiment; a popular or unpopular sentiment; or a combination thereof (e.g., indicating both whether the potential reference MMCE is popular and whether the response to the potential reference MMCE is, for example, good, bad, or indifferent).

As noted above, a strong context is determined when, e.g., there are at least a predetermined threshold number or proportion of concepts which satisfy the same predetermined condition. To this end, determining the context for an MMCE may include, but is not limited to, correlating among a plurality of signatures generated to metadata of the MMCE, or correlating between signatures generated to the MMCE itself (or portions thereof) with signatures generated to the other found MMCEs. As non-limiting examples, a strong positive context may be determined when at least 100 concepts represented by signatures generated to comments of an MMCE are related to a positive sentiment, when at least 60% of concepts represented by signatures generated to the comments of the MMCE are related to a negative sentiment, when concepts represented by signatures generated to at least 5000 MMCEs are correlated with a signature representing the MMCE, and the like.

In an embodiment, the trending content identifier 130 may be configured to generate a strength score for each determined context. The strength score indicates a relative strength of the context with respect to, e.g., other contexts, and may be utilized to rank contexts, potential reference MMCEs, or both, in order of trendiness (e.g., from high to low). The strength score may be generated based on, but not limited to, a number of correlated signatures related to a particular sentiment, a percentage of correlated signatures related to a particular sentiment, or both.

In an embodiment, the trending content identifier 130 is configured to store the determined contexts in, e.g., a database (not shown). In an embodiment, the trending content identifier 130 communicates with the database through the network 110. In other non-limiting configurations, the trending content identifier 130 is directly connected to the database.

In another embodiment, the trending content identifier 130 may be configured to generate and store a source indicator indicating a source (e.g., one of the data sources 150) of the potential reference MMCEs utilized to determine each context. In a further embodiment, one or more of the contexts may be determined based on signatures generated for potential reference MMCEs from the same data source 150. Determining contexts based on potential reference MMCEs obtained from the same source may allow for, e.g., tracking trendiness of content within each source. As a non-limiting example, trendiness of certain content on Facebook®, on Instagram®, and on Twitter® may be tracked by determining contexts for potential reference MMCEs related to the content from each social media website, thereby allowing for comparison of, e.g., efficiency of delivering advertisements among the social media websites.

In an embodiment, based on the determined contexts, the trending content identifier 130 is configured to determine a sentiment associated with each potential reference MMCE. In a further embodiment, the determined sentiment may be a sentiment represented by a strong context of the reference MMCE. For example, if a strong negative context and a weak (i.e., not strong) positive context are determined for the potential reference MMCE, the determined sentiment may be negative.

In a non-limiting example implementation, the trending content identifier 130 generates a plurality of signatures representing metadata of an image of five people drinking beers. The metadata indicates that the image has received 10,000 “likes” of the image on social media and that there are 7,000 comments to the image including the word “love.” The signatures generated to the metadata are correlated to determine a context. Based on the context, a “positive” sentiment is determined. Accordingly, the image may be determined to be trending and utilized as a reference MMCE.

As another non-limiting example implementation, the trending content identifier 130 accesses a plurality of potential reference MMCEs from a data source 150, each showing a crowd of people in Central Park, New York City. Signatures are generated for the accessed reference MMCEs, where the concept of at least some of the generated signatures indicate that the crowd is at a concert by the singer Paul McCartney in Central Park. The concepts are correlated to determine a sentiment. Based on a large number of signatures related to the concert and on a large number of signatures representing comments on the reference MMCEs, it is determined that the sentiment is a strong sentiment (i.e., that the content is highly popular). Further, based on signatures representing positive concepts (e.g., signatures generated based on comments indicating positive statements such as “like” and “yay!”), it is determined that the sentiment is a strong positive sentiment. Accordingly, one or more of the potential reference MMCEs showing the Paul McCartney concert are utilized as reference MMCEs.

It should be noted that the network diagram 100 shown in FIG. 1 is merely an example and does not limit the disclosed embodiments. Further, it should be noted that a single user device 120 is shown in FIG. 1 merely for simplicity purposes. Multiple user devices may be communicatively connected to the trending content identifier 130 without departing from the scope of the disclosure, and each may send queries and be provided with appropriate recommendations of trending content respective thereof. Additionally, in some implementations, the trending content identifier 130 may be included in or installed on the user device 120.

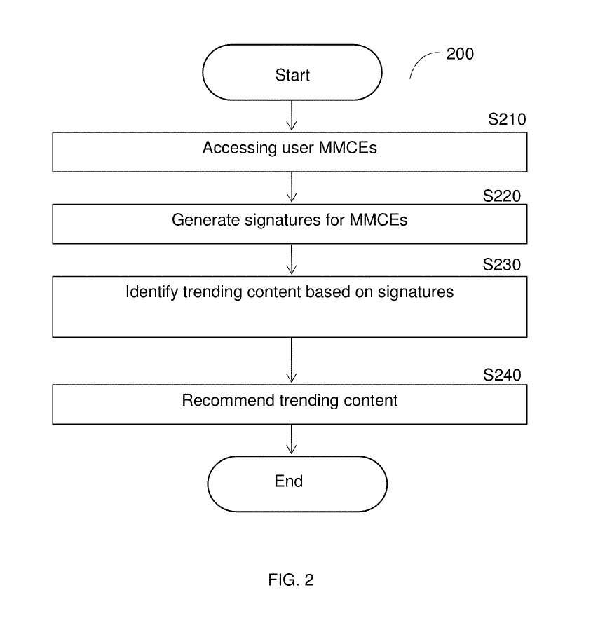

FIG. 2 is an example flowchart 200 describing a method for recommending trending content according to an embodiment. In an embodiment, the method may be performed by the trending content identifier 130.

At S210, one or more input multimedia content elements (MMCEs) are accessed. In an embodiment, the input MMCEs are received or retrieved from a user device. In another embodiment, the input MMCEs may be retrieved from a data source, such as a social media website server of a social media website for which the user has an account. Each input MMCE is content to be potentially shared and may be, for example, an image, a graphic, a video stream, a video clip, an audio stream, an audio clip, a video frame, a photograph, an image of signals, combinations thereof, and portions thereof.

At S220, at least one signature is caused to be generated for each input MMCE. The signatures are generated as described further herein below with respect to FIGS. 3 and 4. In an embodiment, S220 includes sending, to a signature generator system, the input MMCEs, and receiving, from the signature generator system, the signatures generated for each of the input MMCEs. In another embodiment, S220 may include generating the signatures for each input MMCE.

At S230, each generated signature is compared to signatures of a plurality of reference MMCEs to determine at least one matching reference MMCE. In an embodiment, a reference MMCE may match an input MMCE if signatures of the reference MMCE match signatures of the input MMCE above a predetermined threshold. The reference MMCEs may be, e.g., retrieved from data sources. Each reference MMCE may be an MMCE that is trending, e.g., as indicated by a context of the reference MMCE. The reference MMCEs may be associated with predetermined trending contexts, or S230 may include determining the context of each of a plurality of MMCEs stored in, e.g., one or more data sources.

In an embodiment, the reference MMCEs are accessed by crawling through one or more data sources (e.g., the data sources 150, FIG. 1) to retrieve the reference MMCEs. As a non-limiting example, the crawling may be performed through social media networks, web sites, blogs, news feeds, multimedia channels, or any platform in which MMCEs may be trending. In a further embodiment, S230 may include obtaining metadata associated with the reference MMCEs. The reference MMCEs, metadata, or both, may be received, or may be retrieved. The retrieval may be, but is not limited to, at predetermined time intervals, thereby allowing for tracking trends dynamically.

In an embodiment, S230 may further include selecting the reference MMCEs from among a plurality of potential reference MMCEs based on a context of each potential reference MMCE, where each context indicates a sentiment. The potential reference MMCEs may be, e.g., MMCEs stored in one or more data sources. In a further embodiment, a sentiment value of each potential reference MMCE is determined. In another embodiment, S230 includes identifying a strong context with respect to a certain sentiment value (e.g., positive, neutral, or negative; popular or unpopular; etc.) by checking if a predetermined threshold (e.g., a threshold number or proportion) of concepts satisfy the same predetermined condition. In an embodiment, the predetermined condition is set with respect to a certain sentiment value. For example, if 70% of the concepts represented by signatures generated for metadata of the MMCE can be considered as trending towards a positive sentiment, then a strong context of positive sentiment may be identified. In another embodiment, the predetermined condition is set with respect to a volume of similar MMCEs. For example, if signatures of at least 5000 other MMCEs are correlated to at least one signature generated for a MMCE, a strong context of popular sentiment may be identified as a trend.

To this end, in an embodiment, S230 may include determining a context of each potential reference MMCE. In a further embodiment, determining the context of each potential reference MMCEs includes correlating among signatures of the potential reference MMCE. The signatures may include signatures generated for metadata of the potential reference MMCE. The metadata may include, but is not limited to, responses, view data (e.g., number of viewers, number of views, number of clicks, number of downloads, etc.), time indicators, combinations thereof, and the like. The responses may be in the form of, for example, explicit identifiers of approval and disapproval or interest and disinterest (e.g., “likes”, “dislikes”, “upvotes”, “downvotes”, etc.), comments, numbers of comments, rating values (e.g., numerical values on a scale of 1 to 10), combinations thereof, and the like. The comments may include, but are not limited to, text, multimedia content (e.g., emoji), combinations thereof, and the like.

In another embodiment, S230 may include obtaining the plurality of sentiment signatures representing indicators of sentiments. The indicators may be predetermined indicators of known sentiments. Example sentiments may include, but are not limited to, a positive sentiment, a neutral sentiment, or a negative sentiment; popular or unpopular; a combination thereof; and the like. Each sentiment indicator signature may be generated to a predetermined indicator of a known sentiment. In a further embodiment, the sentiment indicator signatures may include signatures generated to responses such as, but not limited to, sentiment-related language (e.g., “love,” “like,” “hate,” “dislike,” “meh,” “yay,” “enjoy,” etc.), emoji (e.g., smiley face, frowny face, thumbs up, thumbs down, etc.), view data (e.g., high numbers of likes or upvotes, high numbers of dislikes, etc.), numbers of comments, number of clicks, number of downloads, time pointers associated therewith, combinations thereof, and the like. In yet a further embodiment, S230 includes comparing the correlated signatures of each determined context to the obtained sentiment signatures and determining, based on the comparison, a sentiment for each context. For example, if correlated signatures of a context match a sentiment signature representing a positive sentiment above a predetermined threshold, the sentiment for the context may be determined as positive.

A trend is determined based on a determined sentiment threshold. In an embodiment, a trend is determined based on the presence or absence of a predetermined number of certain sentiment signatures, namely a sentiment threshold. In a non-limiting example, if an MMCE is associated with a strong context, a trend is determined to exist. For example, a trend may be determined to exist based on 5,000,000 likes on a YouTube® video, based on 2,000,000 comments including the word “great,” and the like. As a non-limiting example of a sentiment threshold, a threshold sentiment value is predetermined to be a minimum of 2,000,000 likes or 1,000,000 comments to determine an MMCE as trending. In a further example, a sentiment threshold is met when a required sentiment, such as a strong positive context, is met.

At S240, at least one trending MMCE is recommended. The recommended at least one trending MMCE includes each input MMCE matching at least one trending reference MMCE. In an embodiment, S240 includes generating a notification including at least one of: the at least one trending MMCE, and an indication of the at least one trending MMCE. The notification may be sent to, for example, a user device (e.g., the user device 120, FIG. 1) for display thereon. The notification may include, but is not limited to, a pointer to one or more MMCEs related to the determined trends, a textual representation of the determined trends (e.g., as indicated by the determined context and sentiment for each trend), the trending score of each trend, a combination thereof, and the like. In an embodiment, S240 may also include uploading one or more recommended MMCEs found on a user device to a remote server.

In a further embodiment, the recommendation may include notification prompting a user to post the recommended MMCEs to a social network. In a non-limiting example, if a user device has stored thereon a picture of a person at a Paul McCartney concert in Central Park, and the signature of that picture is determined to be a successful match to MMCEs related to the trend of a Paul McCartney concert, a notification prompting the user of the user device to upload the picture from the user device to a social platform, such as Twitter®, is displayed on the user device. In another embodiment, the picture of the user at the concert is uploaded directly to the Twitter® account without requiring user input.

FIGS. 3 and 4 illustrate the generation of signatures for the MMCEs by the SGS 140 according to one embodiment. An exemplary high-level description of the process for large scale matching is depicted in FIG. 3. In this example, the matching is for a video content.

Video content segments 2 from a Master database (DB) 6 and a Target DB 1 are processed in parallel by a large number of independent computational Cores 3 that constitute an architecture for generating the Signatures (hereinafter the “Architecture”). Further details on the computational Cores generation are provided below. The independent Cores 3 generate a database of Robust Signatures and Signatures 4 for Target content-segments 5 and a database of Robust Signatures and Signatures 7 for Master content-segments 8. An exemplary and non-limiting process of signature generation for an audio component is shown in detail in FIG. 4. Finally, Target Robust Signatures and/or Signatures are effectively matched, by a matching algorithm 9, to Master Robust Signatures and/or Signatures database to find all matches between the two databases.

To demonstrate an example of the signature generation process, it is assumed, merely for the sake of simplicity and without limitation on the generality of the disclosed embodiments, that the signatures are based on a single frame, leading to certain simplification of the computational cores generation. The Matching System is extensible for signatures generation capturing the dynamics in-between the frames.

The Signatures' generation process is now described with reference to FIG. 4. The first step in the process of signatures generation from a given speech-segment is to breakdown the speech-segment to K patches 14 of random length P and random position within the speech segment 12. The breakdown is performed by the patch generator component 21. The value of the number of patches K, random length P and random position parameters is determined based on optimization, considering the tradeoff between accuracy rate and the number of fast matches required in the flow process of the trending content identifier 130 and the SGS 140. Thereafter, all the K patches are injected in parallel into all computational Cores 3 to generate K response vectors 22, which are fed into a signature generator system 23 to produce a database of Robust Signatures and Signatures 4.

In order to generate Robust Signatures, i.e., Signatures that are robust to additive noise L (where L is an integer equal to or greater than 1) by the Computational Cores 3 a frame ‘i’ is injected into all the Cores 3. Then, Cores 3 generate two binary response vectors: \vec{S} which is a Signature vector, and \vec{RS} which is a Robust Signature vector.

For generation of signatures robust to additive noise, such as White-Gaussian-Noise, scratch, etc., but not robust to distortions, such as crop, shift and rotation, etc., a core Ci={ni} (1≦i≦L) may consist of a single leaky integrate-to-threshold unit (LTU) node or more nodes. The node ni equations are:

$${V}_{i} = {\sum }_{j} {w}_{ij} {k}_{j}$$

$$ni = θ ( Vi - Thx )$$

where, θ is a Heaviside step function; wij is a coupling node unit (CNU) between node i and image component j (for example, grayscale value of a certain pixel j); kj is an image component ‘j’ (for example, grayscale value of a certain pixel j); ThX is a constant Threshold value, where ‘x’ is ‘S’ for Signature and ‘RS’ for Robust Signature; and Vi is a Coupling Node Value.

The Threshold values ThX are set differently for Signature generation and for

Robust Signature generation. For example, for a certain distribution of Vi values (for the set of nodes), the thresholds for Signature (ThS) and Robust Signature (ThRS) are set apart, after optimization, according to at least one or more of the following criteria:

For: Vᵢ>Th_{RS}

1−p(V>Th_{S})−1−(1−ε)^{l}<<1 1:

i.e., given that l nodes (cores) constitute a Robust Signature of a certain image l, the probability that not all of these l nodes will belong to the Signature of same, but noisy image, Ĩ is sufficiently low (according to a system's specified accuracy).

p(Vᵢ>Th_{RS})≈l/L 2:

i.e., approximately l out of the total L nodes can be found to generate a Robust Signature according to the above definition.

3: Both Robust Signature and Signature are Generated for Certain Frame i.

It should be understood that the generation of a signature is unidirectional, and typically yields lossless compression, where the characteristics of the compressed data are maintained but the uncompressed data cannot be reconstructed. Therefore, a signature can be used for the purpose of comparison to another signature without the need of comparison to the original data. The detailed description of the Signature generation can be found in U.S. Pat. Nos. 8,326,775 and 8,312,031, assigned to the common assignee, which are hereby incorporated by reference for all the useful information they contain.

A Computational Core generation is a process of definition, selection, and tuning of the parameters of the cores for a certain realization in a specific system and application. The process is based on several design considerations, such as:

(a) The Cores should be designed so as to obtain maximal independence, i.e., the projection from a signal space should generate a maximal pair-wise distance between any two cores' projections into a high-dimensional space.

(b) The Cores should be optimally designed for the type of signals, i.e., the Cores should be maximally sensitive to the spatio-temporal structure of the injected signal, for example, and in particular, sensitive to local correlations in time and space. Thus, in some cases a core represents a dynamic system, such as in state space, phase space, edge of chaos, etc., which is uniquely used herein to exploit their maximal computational power.

(c) The Cores should be optimally designed with regard to invariance to a set of signal distortions, of interest in relevant applications.

A detailed description of the Computational Core generation and the process for configuring such cores is discussed in more detail in the above-mentioned U.S. Pat. No. 8,655,801.

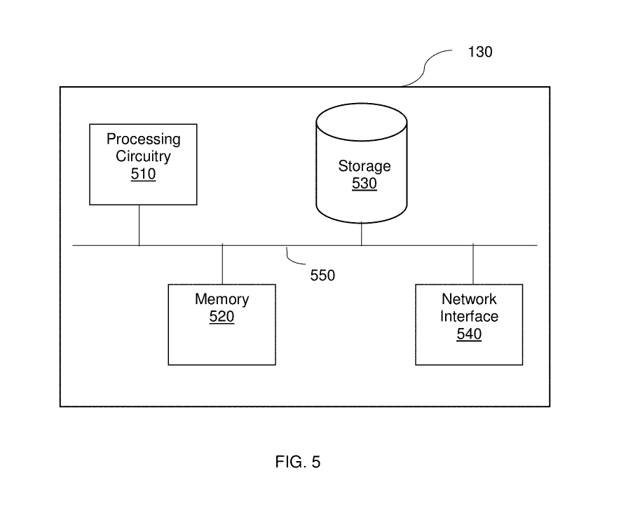

FIG. 5 is an example block diagram of the trending content identifier 130 according to an embodiment. The trending content identifier 130 includes a processing circuitry 510 coupled to a memory 520, a storage 530, and a network interface 540. In an embodiment, the components of the trending content identifier 130 may be communicatively connected via a bus 550.

The processing circuitry 510 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information. In an embodiment, the processing circuitry 510 may be realized as an array of at least partially statistically independent computational cores. The properties of each computational core are set independently of those of each other core, as described further herein above.

The memory 520 may be volatile (e.g., RAM, etc.), non-volatile (e.g., ROM, flash memory, etc.), or a combination thereof. In one configuration, computer readable instructions to implement one or more embodiments disclosed herein may be stored in the storage 530.

In another embodiment, the memory 520 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 510, cause the processing circuitry 510 to perform the various processes described herein. Specifically, the instructions, when executed, cause the processing circuitry 510 identify trending content based on context as described herein.

The storage 530 may be magnetic storage, optical storage, and the like, and may be realized, for example, as flash memory or other memory technology, CD-ROM, Digital Versatile Disks (DVDs), or any other medium which can be used to store the desired information.

The network interface 540 allows the trending content trending content identifier 130 to communicate with the signature generator system 140 for the purpose of, for example, sending MMCEs, receiving signatures, and the like. Further, the network interface 540 allows the trending content identifier 130 to communicate with the client device 120 for the purpose of, for example, sending notifications, and the like. Additionally, the network interface 540 allows the trending content identifier 130 to communicate with the data sources 170 in order to search for MMCEs.

It should be understood that the embodiments described herein are not limited to the specific architecture illustrated in FIG. 5, and other architectures may be equally used without departing from the scope of the disclosed embodiments. In particular, the trending content identifier 130 may further include a signature generator system configured to generate signatures as described herein without departing from the scope of the disclosed embodiments.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for recommending trending content, comprising:
causing generation of at least one signature for each of at least one input multimedia content element, wherein each signature represents a concept, wherein each concept is a collection of signatures and metadata describing the concept;
comparing the generated signatures to signatures of a plurality of reference multimedia content elements, wherein each reference multimedia content element is associated with a context indicating a trend;
determining, based on the comparison, at least one trending multimedia content element of the at least one input multimedia content element; and
generating a recommendation notification, wherein the recommendation notification includes at least one of: the at least one trending multimedia content element, and an indication of the at least one trending multimedia content element.

2. The method of claim 1, further comprising:
determining, based on a context of each of a plurality of potential reference multimedia content elements, a sentiment of each potential reference multimedia content element, wherein each reference multimedia content element is one of the potential reference multimedia content elements having a sentiment meeting a sentiment threshold.

3. The method of claim 2, further comprising:
generating a plurality of signatures for each potential reference multimedia content element; and
correlating the concepts represented by the signatures generated for each potential reference multimedia content element to determine the context of each potential reference multimedia content element.

4. The method of claim 3, wherein generating the plurality of signatures for each reference multimedia content element further comprises:
generating a plurality of signatures to metadata associated with the reference multimedia content element, wherein the concepts correlated for each potential reference multimedia content element include concepts represented by the plurality of signatures generated to the metadata of the reference multimedia content element.

5. The method of claim 4, wherein the metadata includes at least one of: a number of likes, a number of dislikes, a number of upvotes, a number of downvotes, at least one comment, a number of comments, at least one rating value, a number of viewers, a number of views, a number of clicks, and a number of downloads.

6. The method of claim 1, wherein the recommendation notification further includes a textual representation of the at least one determined trending multimedia content element.

7. The method of claim 1, further comprising:
uploading the at least one trending multimedia content element.

8. The method of claim 1, wherein each signature is robust to noise and distortions.

9. The method of claim 1, wherein each signature is generated by a signature generator system, wherein the signature generator system includes a plurality of computational cores configured to receive a plurality of unstructured data elements, each computational core of the plurality of computational cores having properties that are at least partly statistically independent of other of the computational cores, wherein the properties of each core are set independently of each other core.

10. A non-transitory computer readable medium having stored thereon instructions for causing a processing circuitry to perform a process, the process comprising:
causing generation of at least one signature for each of at least one input multimedia content element, wherein each signature represents a concept, wherein each concept is a collection of signatures and metadata describing the concept;
comparing the generated signatures to signatures of a plurality of reference multimedia content elements, wherein each reference multimedia content element is associated with a context indicating a trend;
determining, based on the comparison, at least one trending multimedia content element of the at least one input multimedia content element; and
generating a recommendation notification, wherein the recommendation notification includes at least one of: the at least one trending multimedia content element, and an indication of the at least one trending multimedia content element.

11. A system for recommending trending content, the system comprising:
a processing system; and
a memory coupled to the processing system, the memory containing instructions that, when executed by the processor, configure the system to:
cause generation of at least one signature for each of at least one input multimedia content element, wherein each signature represents a concept, wherein each concept is a collection of signatures and metadata describing the concept;
compare the generated signatures to signatures of a plurality of reference multimedia content elements, wherein each reference multimedia content element is associated with a context indicating a trend;
determine, based on the comparison, at least one trending multimedia content element of the at least one input multimedia content element; and
generate a recommendation notification, wherein the recommendation notification includes at least one of: the at least one trending multimedia content element, and an indication of the at least one trending multimedia content element.

12. The system of claim 11, wherein the system is further configured to:
determine, based on a context of each of a plurality of potential reference multimedia content elements, a sentiment of each potential reference multimedia content element, wherein each reference multimedia content element is one of the potential reference multimedia content elements having a sentiment meeting a sentiment threshold.

13. The system of claim 12, wherein the system is further configured to:
generate a plurality of signatures for each potential reference multimedia content element; and
correlate the concepts represented by the signatures generated for each potential reference multimedia content element to determine the context of each potential reference multimedia content element.

14. The system of claim 13, wherein the system is further configured to:
generate a plurality of signatures to metadata associated with the reference multimedia content element, wherein the concepts correlated for each potential reference multimedia content element include concepts represented by the plurality of signatures generated to the metadata of the reference multimedia content element.

15. The system of claim 14, wherein the metadata includes at least one of: a number of likes, a number of dislikes, a number of upvotes, a number of downvotes, at least one comment, a number of comments, at least one rating value, a number of viewers, a number of views, a number of clicks, and a number of downloads.

16. The system of claim 11, wherein the recommendation notification further includes a textual representation of the at least one trending multimedia content element.

17. The system of claim 11, wherein the system is further configured to:
upload the at least one trending multimedia content element.

18. The system of claim 11, wherein each signature is robust to noise and distortions.

19. The system of claim 11, wherein each signature is generated by a signature generator system, wherein the signature generator system includes a plurality of computational cores configured to receive a plurality of unstructured data elements, each computational core of the plurality of computational cores having properties that are at least partly statistically independent of other of the computational cores, wherein the properties of each core are set independently of each other core.
